(19) United States
(12) Patent Application Publication
(10) Pub. No.: US 2024/0105349 A1
(43) Pub. Date: Mar. 28, 2024

(54) NUCLEAR FUSION SYSTEM, NUCLEAR FUSION METHOD, NUCLIDE TRANSMUTATION LIFE-SHORTENING TREATMENT SYSTEM FOR LONG-LIVED FISSION PRODUCT AND NUCLIDE TRANSMUTATION LIFE-SHORTENING TREATMENT METHOD FOR LONG-LIVED FISSION PRODUCT

(71) Applicant: CHUBU UNIVERSITY EDUCATIONAL FOUNDATION, Aichi (JP)

(72) Inventors: Shinji OKADA, Aichi (JP); Motoyasu SATO, Aichi (JP); Atsuo IIYOSHI, Aichi (JP); Kimitaka ITOH, Aichi (JP); Takashi MUTOH, Aichi (JP); Norimasa YAMAMOTO, Aichi (JP); Yoshiharu TANAHASHI, Aichi (JP)

(73) Assignee: CHUBU UNIVERSITY EDUCATIONAL FOUNDATION, Aichi (JP)

(21) Appl. No.: 18/493,757

(22) Filed: Oct. 24, 2023

Related U.S. Application Data
(63) Continuation of application No. PCT/JP2022/018420, filed on Apr. 21, 2022.

(30) Foreign Application Priority Data
Apr. 25, 2021 (JP) 2021-073711

(51) Int. Cl. G21B 3/00

(52) U.S. Cl. CPC G21B 3/004

(57) ABSTRACT

A nuclear fusion system comprises: a muon generation unit to generate negative muons including electron and positron accelerators for generating electron and positron beams; a gas supply unit to supply to circulate gaseous deuterium or gaseous deuterium-tritium mixture as raw material gas; a Laval nozzle to accelerate the raw material gas to supersonic velocity; and a shock wave cone connected to the Laval nozzle to introduce the raw material gas accelerated to supersonic velocity to generate an oblique shock wave, the raw material gas accelerated to supersonic velocity being introduced into the shock wave cone to generate the oblique shock wave, the oblique shock wave being decelerated to create a high-density gas target in an in-flight manner, the muons generated as a result of causing electrons and positrons to collide with each other being introduced into the high-density gas target thereby to cause a muon-catalyzed nuclear fusion reaction to occur.

### CROSS REFERENCE TO RELATED APPLICATIONS

This is a continuation application of International Patent Application No. PCT/JP2022/018420 filed on Apr. 21, 2022 claiming priority upon Japanese Patent Application No. 2021-073711 filed on Apr. 25, 2021, of which full contents are incorporated herein by reference.

### BACKGROUND OF THE INVENTION

### Field of the Invention

The present invention relates to a nuclear fusion system, a nuclear fusion method, a nuclide transmutation life-reduction treatment system for a long-lived fission product and a nuclide transmutation life-reduction treatment method for a long-lived fission product, through the use of muon-catalyzed nuclear fusion reaction.

### Description of the Background Art

Conventionally, as a nuclear fusion system, magnetic fusion to be caused by confining magnetically a high temperature plasma has been studied. As a nuclear fusion system of another scheme, there has been proposed a method through the use of muon-catalyzed fusion.

In the muon-catalyzed nuclear fusion, a muon (μ⁻) having a mass 207 times heavier than that of an electron and having a negative charge is used. When deuterium or deuterium mixed with tritium is irradiated with a negative muon, such a negative muon causes nuclei to attract each other so as to form a muonic molecule. The negative muon has the same charge as that of the electron, but has a mass approximately 200 times heavier than that of the electron, and therefore, an orbital radius of the muon in a bound state is approximately 1/200 of that of the electron. As a result, assuming that the electron is replaced with the negative muon, it would be easier for the nuclei to approach each other, and therefore, nuclear fusion therebetween would be likely to occur. The negative muon could be involved in such a nuclear reaction many times until it annihilates, which is the action of negative muon like a catalyst.

A muon-catalyzed nuclear fusion reactor has been proposed in, e.g., Patent Document 1.

The inventors of the present invention have studied a muon-catalyzed nuclear reaction so as to propose the in-flight muon-catalyzed fusion (In-Fight Muon-Catalyzed Fusion: IFMCF) as a nuclear fusion reaction in a new field of nuclear reaction positioned intermediately between: a field of low-temperature nuclear fusion through intramolecular resonance with respect to a negative muon introduced into extremely low-temperature solid/liquid-phase hydrogen having significantly low atomic momentum therein; and a field of high-temperature plasma nuclear fusion through two-body collision among ions flying at a high velocity (Patent Document 2).

In the in-flight muon-catalyzed fusion, a high-density gas target can be retained as a nuclear fusion reaction region in an in-flight manner by a shock wave generated in a supersonic flow, and a structure related to the gas target can be cooled by a high-velocity flow. This makes it possible to relax engineering restrictions such as cooling, and to maintain the high-density gas target in a steady and stable manner as the nuclear fusion reaction region without using any large-scale complicated apparatuses, thereby capable of realizing the in-flight muon-catalyzed fusion.

For a method of using the muon-catalyzed nuclear fusion reaction as a neutron source, there has been studied a technology of performing nuclide transmutation of a long-lived fission product (LLFP) so as to reduce its half-life or transmute the LLFP into a stable isotope.

Examples of a major nuclide of the LLFP include ⁷⁹Se, ⁹³Zr, ¹⁰⁷Pd, and ¹³⁵Cs. The nuclide transmutation of the LLFP is performed by irradiating the LLFP with high-intensity neutrons. A nuclear fusion neutron has an energy of 14.1 MeV (in the deuterium-tritium fusion reaction) or 2.45 MeV (in the deuterium-deuterium fusion reaction), and thereby, the nuclear transmutation series can be accurately evaluated. The muon-catalyzed nuclear fusion reaction is suitable for continuously generating such highly-monochromatic neutrons in the form of a high density of flux.

### PRIOR ART DOCUMENTS

### Patent Documents

Patent Document 1: Japanese Patent Application Publication No. 2016-114370
Patent Document 2: International Patent Publication No. WO 2019/168030

### Problems to be Solved

The following problems, however, remain in a muon generation method.

In order to generate a muon having a negative charge (negative muon) necessary for the muon-catalyzed nuclear fusion reaction, there has been generally used a method of irradiating a fixed target such as carbon with a proton beam having an energy of several GeV obtained from a large-scale proton accelerator so as to generate a pion having a negative charge and thereafter allowing the generated pion to decay into the negative muon. By such a method, most of the energy of the accelerated proton has been wasted thermally in the target. Further, in order to prevent the heat melting of the target, a special cooling structure and facility have been needed. Still further, the decay pion has been emitted from the solid target at a large solid angle. It has therefore been necessary to collect pions through the use of a large-diameter magnetic solenoid and cause the collected pions to travel 5 m or longer (until the pions exhaust their life-span to decay into muons). In order to efficiently cause the muon-catalyzed nuclear fusion reaction to occur, it has been necessary to efficiently stop the muons within a reactor core (hydrogen isotope gas target). Thus, the muons desirably have an energy distribution as narrow as possible, i.e., a uniform energy distribution; however, the generated pions and the decaying muons both have a broad energy distribution which has resulted in low stopping efficiency.

For this reason, the improvement in efficiency of generating, transporting, and stopping muons has been a technical problem necessary to be solved.

### SUMMARY OF THE INVENTION

In view of the above, one of the objectives of the present invention is to provide a nuclear fusion system and a nuclear fusion method each enabling a gas target to efficiently capture negative muons by a smaller apparatus. Further, another of the objectives of the present invention is to provide a nuclide transmutation life-reduction treatment system for a long-lived fission product and a nuclide transmutation life-reduction treatment method for a long-lived fission product each enabling nuclide transmutation as a result of efficiently irradiating an LLFP with neutrons generated by the nuclear fusion system and the nuclear fusion method.

### Means for Solving Problems

In order to achieve the above-described objective, according to a first aspect of the present invention, there is used, as technical means, a nuclear fusion system comprising: a muon generation unit configured to generate negative muons, wherein the muon generation unit includes an electron accelerator for generating electron beams and a positron accelerator for generating positron beams; a gas supply unit configured to supply to circulate gaseous deuterium or gaseous deuterium-tritium mixture as raw material gas for a nuclear fusion reaction; a Laval nozzle configured to accelerate the raw material gas supplied from the gas supply unit to supersonic velocity; and a shock wave cone connected to a downstream side of the Laval nozzle configured to introduce thereinto the raw material gas accelerated to supersonic velocity so as to generate an oblique shock wave, wherein the raw material gas supplied from the gas supply unit accelerated by the Laval nozzle to supersonic velocity is introduced into the shock wave cone so as to generate the oblique shock wave, and the generated oblique shock wave is decelerated so as to create a high-density gas target in an in-flight manner, and the negative muons generated by the muon generation unit as a result of causing beamed electrons and beamed positrons to collide with each other are introduced into the high-density gas target thereby to cause a muon-catalyzed nuclear fusion reaction to occur therein.

According to a second aspect of the present invention, there is used, as technical means, the nuclear fusion system in the above-described first aspect, wherein the shock wave cone is configured such that a collision region of electron and positron generated by the muon generation unit is surrounded by the high-density gas target.

According to a third aspect of the present invention, there is used, as technical means, a nuclide transmutation life-reduction treatment system for a long-lived fission product, through the use of the nuclear fusion system in the above-described first or second aspect, the nuclide transmutation life-reduction treatment system comprising: a long-lived fission product treatment unit configured such that the long-lived fission product is arranged so as to surround the high-density gas target, wherein neutrons generated as a result of occurrence of the nuclear fusion reaction in the high-density gas target are introduced into the long-lived fission product so that the long-lived fission product undergoes nuclide transmutation thereby to have a half-life reduced.

According to a fourth aspect of the present invention, there is used, as technical means, the nuclide transmutation life-reduction treatment system for the long-lived fission product in the above-described third aspect, wherein γ rays and/or electron and positron rays generated as a result of collision between the electrons and the positrons are further introduced into the long-lived fission product so that the long-lived fission product undergoes nuclide transmutation thereby to have the half-life reduced.

In order to achieve the above-described objective, according to a fifth aspect of the present invention, there is used, as technical means, a nuclear fusion method comprising the step of: providing a Laval nozzle and a shock wave cone connected to the Laval nozzle configured to generate an oblique shock wave; accelerating, by the Laval nozzle, gaseous deuterium or gaseous deuterium-tritium mixture as raw material gas to supersonic velocity; generating an oblique shock wave as a result of introducing the accelerated raw material gas into the shock wave cone, and decelerating the generated oblique shock wave so as to create a high-density gas target in an in-flight manner; generating negative muons by causing electrons and positrons to collide with each other; and introducing the generated negative muons into the high-density gas target thereby to cause a muon-catalyzed nuclear fusion reaction to occur therein.

According to a sixth aspect of the present invention, there is used, as technical means, a nuclide transmutation life-reduction treatment method for a long-lived fission product, through the use of neutrons generated by the nuclear fusion method in the above-described fifth aspect, the nuclide transmutation life-reduction treatment method comprising the steps of: introducing the generated neutrons into the long-lived fission product arranged so as to surround a nuclear fusion reaction region so that the long-lived fission product undergoes nuclide transmutation thereby to have a half-life reduced.

According to a seventh aspect of the present invention, there is used, as technical means, the nuclide transmutation life-reduction treatment method for the long-lived fission product in the above-described sixth aspect, the nuclide transmutation life-reduction treatment method further comprising the steps of: introducing γ rays and/or electron and positron rays generated by collision between the electrons and the positrons into the long-lived fission product so that the long-lived fission product undergoes nuclide transmutation thereby to have the half-life reduced.

### Advantageous Effects of the Invention

According to the nuclear fusion system in the above-described first aspect of the present invention and the nuclear fusion method in the-above-described fifth aspect of the present invention, the high-density gas target can be retained as the nuclear fusion reaction region in an in-flight manner by the shock wave generated in a supersonic flow. This makes it possible to maintain the high-density gas target as the nuclear fusion reaction region in a steady and stable manner, thereby capable of realizing the in-flight muon-catalyzed fusion. Further, by adopting a configuration where the high-density gas target surrounds the muon generation source, it is possible to improve efficiency of using the generated negative muons. Still further, negative muons are generated by collision between electrons and positrons, and therefore, the negative muons having narrowly-distributed low velocities can be generated. As a result, it is possible to improve the stopping efficiency of negative muons, thereby to provide the nuclear fusion system enabling the high-density gas target to efficiently capture negative muons by a smaller apparatus.

Still further, the nuclide transmutation of the LLFP can be performed by efficiently irradiating the LLFP with the neutrons generated by the muon-catalyzed nuclear fusion, and thereby, the half-life of the LLFP can be reduced. Still further, γ rays generated by collision between electrons and positrons and/or electron and positron rays can also be used for the nuclide transmutation of the LLFP, and therefore, the irradiation time can be reduced and efficiency of the nuclide transmutation treatment for the LLFP can be improved.

### BRIEF DESCRIPTIONS OF THE DRAWINGS

FIG. 1 depicts a schematic view of configuration of a nuclear fusion system and a nuclide transmutation life-reduction treatment system for a long-lived fission product.

FIG. 2 depicts a laterally-cross-sectional view showing schematically a cross-section, perpendicular to an axis direction of the nuclear fusion system, having therein a collision point between electrons and positrons for explanation of a nuclear fusion reaction and a nuclide transmutation treatment method for an LLFP.

FIG. 3 depicts a partial longitudinally-cross-sectional view showing schematically structures of a nuclear fusion system and a nuclide transmutation life-reduction treatment system for a long-lived fission product.

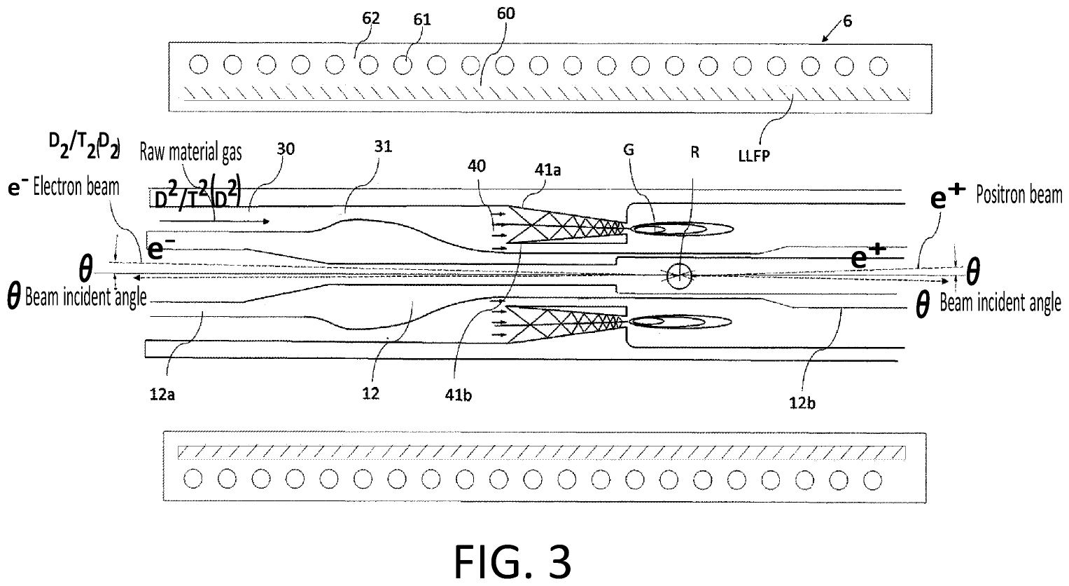

### DESCRIPTIONS OF EMBODIMENTS OF THE INVENTION

Configuration of Nuclear Fusion System

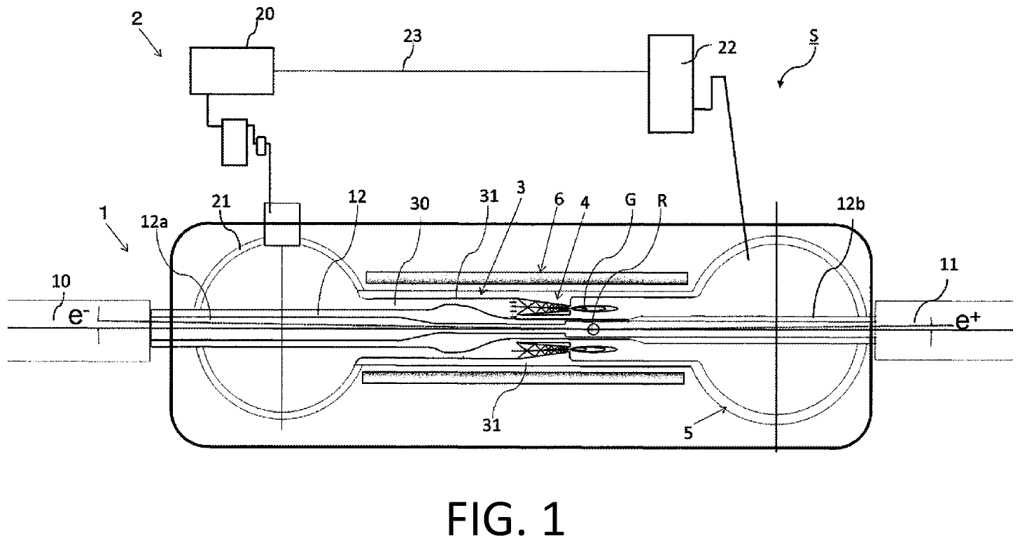

A nuclear fusion system S according to an embodiment of the present invention is described with reference to FIG. 1.

As shown in FIG. 1, the nuclear fusion system S includes a muon generation unit 1, a gas supply unit 2, a Laval nozzle 3, and a shock wave cone 4.

The muon generation unit 1 generates muons necessary for a muon-catalyzed nuclear fusion reaction.

A method of generating muons according to an embodiment of the present invention will be described.

According to an embodiment of the present invention, by paying attention to the fact that positive and negative muons uniform in energy can be directly generated without using a fixed target through head-on collision of an electron beam and a positron beam with center-of-mass energy of 250 MeV (collision with energy of 125 MeV each) greater than or equal to a threshold for generation of a positive and negative muon pair, where the electron beam and the positron beam were caused to collide head-on with each other to generate positive and negative muons. Main reaction processes in the present collide energy region are described below.

e⁺+e⁻→μ⁺+μ⁻(+nγ) (1)

e⁺+e⁻→γ+γ(+nγ) (2)

e⁺+e⁻→e⁺+e⁻(+nγ) (3)
where n of “nγ” denotes an integer of 0 or more, and means the number of low-energy γ rays (approximately 20 MeV or less).

A process of the above-described (1) is a muon generation process, and highly monochromatic positive and negative muons (kinetic energy of approximately 20 MeV) are obtained. A reaction cross-section was estimated to be 1 μbarn by an event generator (BABAYAGA) using a Monte Carlo method of a quantum electrodynamics (QED) process. By a process of the above-described (2), two γ rays of 125 MeV are mainly generated. A process of the above-described (3) is called Bhabha scattering having a large reaction cross-section; however, with respect to a small-angle scattered event, energy loss is recovered by high-frequency reacceleration or the like, and the recovered energy is reused.

The muon generation unit 1 includes an electron accelerator 10, a positron accelerator 11, and a beam duct 12. Well-known accelerators can be used as the electron accelerator 10 and the positron accelerator 11.

The beam duct 12 is a tubular member arranged along an axis of the Laval nozzle 3. The beam duct 12 having an inside thereof retained in vacuum serves as a path for the electron beam and the positron beam.

The beam duct 12 includes an electron beam duct 12a and a positron beam duct 12b. The electron beam duct 12a and the positron beam duct 12b intersect with each other at a small angle θ, e.g., ±12.5 mrad, and are configured such that an electron and a positron collide with each other at an intersection. In a case where the electron beam and the positron beam are prepared by different storage rings, the beam not contributing to the reaction returns the corresponding storage ring again, and is reusable. On the other hand, the energy of a generated pair of positive/negative muons is boosted by the intersection angle, and a deceleration material (beam duct) is made to have a thickness in consideration thereof.

The beam duct 12 may be configured such that the electron beam duct 12a and the positron beam duct 12b directly face each other, and the electron and the positron collide head-on with each other.

A material and a shape (thickness) of the beam duct 12 are appropriately set so as to decelerate the muons to a velocity capturable by a gas target G described below.

The gas supply unit 2 circulates and supplies gaseous deuterium or gaseous deuterium-tritium mixture as raw material gas serving as a target for the nuclear fusion reaction, and may adopt a well-known configuration for circulating and supplying the gas. In an embodiment of the present invention, the gas supply unit 2 includes a compressor 20, an accumulator tank 21, a dump tank 22, a pipe 23, and the like.

The Laval nozzle 3 is configured to accelerate the raw material gas supplied from the gas supply unit 2 to supersonic velocity. The Laval nozzle 3 configured to accelerate the raw material gas to supersonic velocity is connected to the gas supply unit 2 through the accumulator tank 21, and includes: a tubular flow regulation portion 30 configured to allow the raw material gas to pass therethrough at subsonic velocity; a throat portion 31 reduced in diameter with respect to the flow regulation portion 30; and a region connected to the throat portion 31 formed so as to be greater in diameter than the throat portion 31.

The shock wave cone 4 arranged at a downstream side of the Laval nozzle 3, is configured to introduce the raw material gas accelerated to supersonic velocity into an inside thereof, thereby to generate an oblique shock wave.

The shock wave cone 4 is formed, by inserting the beam duct 12 into the Laval nozzle 3, so as to be in a circular tubular shape coaxial with the beam duct 12. The shock wave cone 4 includes a flow path 40 so as to allow the raw material gas to flow therethrough in a longitudinal direction of the shock wave cone 4.

The flow path 40 includes wadges 41 (41a and 41b) for generating the oblique shock wave, inclined toward a downstream side to reduce the flow path 40. The wedge 41a is formed so as to directly communicate with an inner wall of the Laval nozzle 3, and the wedge 41b is arranged with an interval outside the beam duct 12. The shock wave cone 4 generates the oblique shock wave at the wadges 41 through collision with supersonic flows so as to decelerate the oblique shock wave to subsonic velocity, thereby creating, in proximity to an opening end at a downstream side, the gas target G as a high-density gas mass. The gas target G corresponds to a nuclear fusion reaction region.

The shock wave cone 4 may adopt any of various kinds of forms as long as the shock wave cone 4 is configured so as to be aerodynamically balanced with a dynamic pressure of a flow at an upstream side, and a pressure difference between front and rear of the oblique shock wave and a Mach shock wave plane (Ben-Dor, “Shock Wave Reflection Phenomena”, Springer, (1992) ISBN-10-0387977074).

A diffusion tube 5 arranged at a downstream side from a reaction portion 32 of the Laval nozzle 30 is configured to decelerate the raw material gas from supersonic velocity to subsonic velocity.

The nuclear fusion system S may further include a long-lived fission product (LLFP) treatment unit 6. In such a case, the nuclear fusion system S is configured as a nuclide transmutation life-reduction treatment system for a long-lived fission product.

The long-lived fission product treatment unit 6 is formed in a circular tubular shape coaxial with the beam duct 12 so as to surround the Laval nozzle 3, and internally includes a holding portion 60 for holding an LLFP aggregate. The holding portion 60 is configured to arrange the LLFP aggregate at a high-neutron intensity position, i.e., at a position surrounding the high-density gas target G (nuclear fusion reaction region) inside a reaction portion 32 of the Laval nozzle 3.

Arranging the LLFP aggregate in the above-described manner makes it possible to efficiently receive neutrons emitted from a neutron source toward a wide region, by the LLFP aggregate.

In the long-lived fission product treatment unit 6, the LLFP is stacked in a cylindrical shape so as to coaxially surround the nuclear fusion reaction region. The long-lived fission product treatment unit 6 performs (1) life-reduction treatment for the LLFP through irradiation of a high-intensity high-velocity neutrons generated by the muon-catalyzed nuclear fusion reaction, and (2) radiation absorption as a radiation shielding. Further, the long-lived fission product treatment unit 6 includes (3) a cooling unit 62 configured to cool a shielding member 61 by circulating a liquid medium such as pure water so as to serve as the deceleration material for the neutrons.

The nuclear fusion system S may adopt a configuration including a heat exchanger and a power generator at a downstream side from the diffusion tube 5 so as to generate power by using exhaust heat. Further, the nuclear fusion system S may also include a helium separator at a downstream from the heat exchanger so as to collect helium from the gas after reaction (not shown).

Each of the beam ducts 12, the shock wave cone 4, and the long-lived fission product treatment unit 6 may adopt any of various kinds of forms without departing from the spirit thereof, and, e.g., may be arranged at a plurality of positions or divided.

Nuclear Fusion Method

A method of operating the nuclear fusion system S will be described.

As a conventional technique for decelerating and capturing high-energy muons, a method using liquid droplets of high-concentration deuterium or tritium has been studied. Further, as for the muons having energy attenuated to approximately 5 MeV, there has been conducted an experiment that the attenuated muons are allowed to pass through gaseous deuterium or tritium having pressure of approximately 0.1 atm, and there has been reported a result of the experiment that a range of the muons is approximately 0.2 to 0.3 m. A concept of the nuclear fusion system S is that a supersonic flow of the raw material gas is generated by the Laval nozzle 3, and the shock wave cone 4 is provided in a path of the supersonic flow to generate a shock wave, thereby creating a Mach shock wave plane. The Mach shock wave plane is used as a nuclear fusion reaction region, and low-velocity muons are generated in proximity to the nuclear fusion reaction region, thereby the generated muons transport to the nuclear fusion region with less loss.

First, the gas supply unit 2 continuously supplies gaseous deuterium or gaseous deuterium-tritium mixture as the raw material gas, to the Laval nozzle 3. A case of using the gaseous deuterium-tritium mixture as the raw material gas will be described below.

To steadily operate the nuclear fusion system S by using the gaseous deuterium-tritium mixture, it is necessary to adjust components of the raw material gas such that a necessary amount of the gaseous tritium (t) to the gaseous deuterium (D) is obtained, and the composition of the raw material gas is preferably d:t=1:1.

The gaseous deuterium-tritium mixture supplied to the Laval nozzle 3 passes through the flow regulation portion 30 at subsonic velocity, and is accelerated to supersonic velocity, e.g., Mach 3 to 5 when introduced into the reaction portion 32 through the throat portion 31.

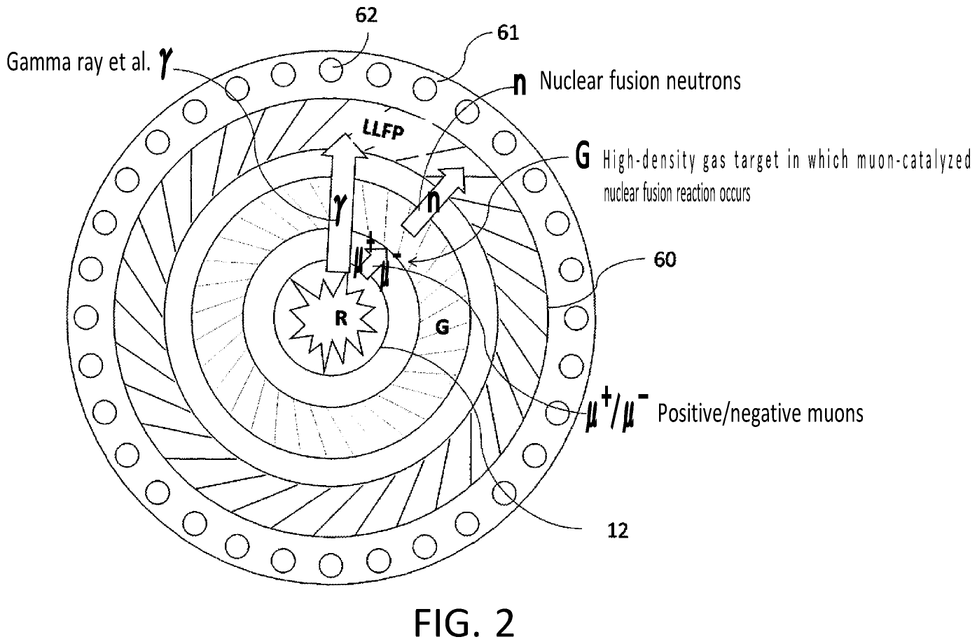

The accelerated gaseous deuterium-tritium mixture is introduced into the flow path 40 of the shock wave cone 4, collides with the wedges 41. As a result, the oblique shock wave is generated as illustrated in FIG. 2. The gaseous deuterium-tritium mixture not introduced into the flow path 40 of the shock wave cone 4 forms a low-pressure supersonic flow.

The oblique shake wave is decelerated toward a downstream side, and forms a high-density shock wave plane called a Mach shock wave in proximity to a downstream end part of the flow path 40.

An intense high-density standing wave is steadily and stably retained in the form of aerodynamically floating in a space. The shock wave plane has supersonic velocity at an upstream side. As a result, the shock wave plane does not transmit any instability based on acoustic variation generated in a gas target to an upstream side. For example, inhibition of generation of the high-density gas target does not occur in principle by large pressure variation caused by the nuclear fusion reaction and the like. The high-density gas target G therefore forms steadily a reaction region of negative muon nuclear fusion.

A part of the supersonic flow supplied from the Laval nozzle 3 flows through a gap between the wadge 41b and the beam duct 12, meets the gas target G at a nuclear fusion reaction region at transonic velocity to subsonic velocity while maintaining supersonic velocity, and forms a boundary layer between the beam duct 12 and the nuclear fusion reaction region. The boundary layer makes it possible to reduce a thickness of a tube wall of the beam duct 12 in proximity to the nuclear fusion reaction region. The thickness of the beam duct 12 for optimizing the energy of muons generated at an electron/positron collision region R is reduced, which makes it possible to minimize muon loss in a metal tube wall.

Subsequently, the muon generation unit 1 causes the electron beam generated by the electron accelerator 10 and the positron beam generated by the positron accelerator 11 to collide with each other in proximity to center R (collision region) in the high-density gas target G through the beam duct 12.

Negative and positive muons are isotropically emitted from the electron/positron collision region R. However, in a case of collision at a small intersection angle, the energy of the muons is boosted by the intersection angle. Further, two high-energy γ rays of approximately 125 MeV, a low-energy γ ray, and electrons and positrons by Bhabha scattering are radiated to an angle shallow relative to the beams.

The negative muons generated at the electron/positron collision region R are introduced into the gas target G surrounding the collision region R. The negative muons are captured by the gas target G, and a muonic atom having the captured negative muon is accordingly generated. As a result, muon-catalyzed nuclear fusion reaction occurs, and high-velocity neutrons of 14.1 MeV are emitted from the nuclear fusion reaction region.

The gas within the region flows in the region at supersonic velocity and flows out from the region at subsonic velocity. The high-velocity flow of the raw material gas has a function of supplying new raw material gas to the gas target G, i.e., the nuclear fusion reaction region, and removing heat generated by the nuclear fusion reaction.

In proximity to an entrance of the nuclear fusion region, fresh cooling gas is supplied by a supersonic flow. The gas in a region at a downstream from an interior of the target is the subsonic flow of approximately Mach 1, and a temperature of an edge supporting the target can be maintained at 200° C. or less by the outflow gas. As a result, the gas target G can be prevented from becoming high temperature in a short period of time and being scattered, by large energy of a generated a ray, thereby stably maintaining the nuclear fusion reaction.

Life-Treatment Method for Long-Lived Fission Product

An intense neutron ray of 14.1 MeV radiated from the nuclear fusion reaction region can be used for treatment for the long-lived fission product (LLFP) discharged from a nuclear fission reactor and the like.

The neutron ray reaches the LLFP held by the long-lived fission product treatment unit 6 arranged outside the nuclear fusion reaction region, and is nuclear-transmuted into a stable isotope through (n, 2n) reaction with an atomic nucleus of the LLFP and capturing of the decelerated neutrons. This makes it possible to reduce a half-life of the LLFP.

Further, nuclide transmutation treatment for the LLFP is also performed by photonuclear reaction of the LLFP with γ ray radiated at the same time, electron ray and positron ray from the scattering, and γ ray generated by an electromagnetic shower thereof.

The heat and the low-velocity thermal neutrons generated inside the long-lived fission product treatment unit 6 are shielded by a shielding member and cooled by a cooling unit, and the exhaust heat is collected. By using the shielding member and the cooling unit in combination, the shielding member shields the neutrons to prevent them from leaking to an exterior, and the cooling unit cools a large amount of heat generated when the shielding member shields the neutrons. Further, the exhaust heat can be collected and effectively used for power generation and the like. Excess neutrons and a particles are decelerated and shielded by the shielding member.

A normal nuclear fusion reactor cannot be used as such a small neutron source of high-density flux of neutrons. It is shown, therefore, that the nuclear fusion system S according to an embodiment of the present invention is suitable as a neutron source for the life-reduction treatment for the LLFP.

### Effects Achieved by Embodiments

According to the nuclear fusion system S and the nuclear fusion method of the present invention, the high-density gas target can be retained as the nuclear fusion reaction region in an in-flight manner by the shock wave generated in the supersonic flow. The high-density gas target can therefore be maintained as the nuclear fusion reaction region in a steady and stable manner, which makes it possible to realize the in-flight muon-catalyzed fusion. At this time, when the muon generation source is positioned inside the gas target, it is possible to improve use efficiency of the muons. Further, since the muons are generated by collision of the electrons and the positrons, the muons having a narrow energy distribution and low velocity can be generated. As a result, it is possible to provide the nuclear fusion system enabling the gas target to efficiently capture the muons with a smaller apparatus. Still further, the gas target can be used as the high-density neutron source necessary for the nuclide transmutation treatment for the LLFP.

According to the nuclide transmutation life-reduction treatment system S for the long-lived fission product and the nuclide transmutation life-reduction treatment method for the long-lived fission product of the present invention, the nuclide transmutation of the LLFP can be performed by efficiently irradiating the LLFP with neutrons generated by the nuclear fusion system S and the nuclear fusion method, and the half-life of the LLFP can be reduced. Further, since γ ray generated by collision between electron and positron and/or electron ray and positron ray can be used, the irradiation period of time can be reduced and efficiency of the nuclide transmutation treatment for the LLFP can be improved.

### Other Embodiments

In the nuclear fusion system S and the nuclear fusion method, a DD nuclear fusion reaction using gaseous deuterium as the raw material gas may also be handled.

### REFERENCE NUMERALS

1 Muon generation unit
10 Electron accelerator
11 Positron accelerator
12 Beam duct
12a Electron beam duct
12b Positron beam duct
2 Gas supply unit
20 Compressor
21 Accumulator tank
22 Dump tank
23 Pipe
3 Laval nozzle
30 Flow regulation portion
31 Throat portion
4 Shock wave cone
40 Flow path
41 Wedge
5 Diffusion tube
6 Long-lived fission product treatment unit
60 Holding portion
61 Shielding member
62 Cooling unit
G Gas target
R Collision region
S Nuclear fusion system

What is claimed is:

1. A nuclear fusion system comprising:
a muon generation unit configured to generate negative muons, wherein the muon generation unit includes an electron accelerator for generating electron beams and a positron accelerator for generating positron beams;
a gas supply unit configured to supply to circulate gaseous deuterium or gaseous deuterium-tritium mixture as raw material gas for a nuclear fusion reaction;
a Laval nozzle configured to accelerate the raw material gas supplied from the gas supply unit to supersonic velocity; and
a shock wave cone connected to a downstream side of the Laval nozzle configured to introduce thereinto the raw material gas accelerated to supersonic velocity so as to generate an oblique shock wave,
wherein the raw material gas supplied from the gas supply unit accelerated by the Laval nozzle to supersonic velocity is introduced into the shock wave cone so as to generate the oblique shock wave, and the generated oblique shock wave is decelerated so as to create a high-density gas target in an in-flight manner, and
the negative muons generated by the muon generation unit as a result of causing beamed electrons and beamed positrons to collide with each other are introduced into the high-density gas target thereby to cause a muon-catalyzed nuclear fusion reaction to occur therein.

2. The nuclear fusion system, according to claim 1, wherein
the shock wave cone is configured such that a collision region of electron and positron generated by the muon generation unit is surrounded by the high-density gas target.

3. A nuclide transmutation life-reduction treatment system for a long-lived fission product, through the use of the nuclear fusion system according to claim 2, the nuclide transmutation life-reduction treatment system comprising:
a long-lived fission product treatment unit configured such that the long-lived fission product is arranged so as to surround the high-density gas target,
wherein neutrons generated as a result of occurrence of the nuclear fusion reaction in the high-density gas target are introduced into the long-lived fission product so that the long-lived fission product undergoes nuclide transmutation thereby to have a half-life reduced.

4. The nuclide transmutation life-reduction treatment system for the long-lived fission product according to claim 3, wherein
γ rays and/or electron and positron rays generated as a result of collision between the electrons and the positrons are further introduced into the long-lived fission product so that the long-lived fission product undergoes nuclide transmutation thereby to have the half-life reduced.

5. A nuclear fusion method comprising the step of:
providing a Laval nozzle and a shock wave cone connected to the Laval nozzle configured to generate an oblique shock wave;
accelerating, by the Laval nozzle, gaseous deuterium or gaseous deuterium-tritium mixture as raw material gas to supersonic velocity;
generating an oblique shock wave as a result of introducing the accelerated raw material gas into the shock wave cone, and decelerating the generated oblique shock wave so as to create a high-density gas target in an in-flight manner;
generating negative muons by causing electrons and positrons to collide with each other; and
introducing the generated negative muons into the high-density gas target thereby to cause a muon-catalyzed nuclear fusion reaction to occur therein.

6. A nuclide transmutation life-reduction treatment method for a long-lived fission product, through the use of neutrons generated by the nuclear fusion method according to claim 5, the nuclide transmutation life-reduction treatment method comprising the steps of:
introducing the generated neutrons into the long-lived fission product arranged so as to surround a nuclear fusion reaction region so that the long-lived fission product undergoes nuclide transmutation thereby to have a half-life reduced.

7. The nuclide transmutation life-reduction treatment method for the long-lived fission product according to claim 6, the nuclide transmutation life-reduction treatment method further comprising the steps of:
introducing γ rays and/or electron and positron rays generated by collision between the electrons and the positrons into the long-lived fission product so that the long-lived fission product undergoes nuclide transmutation thereby to have the half-life reduced.
